(19) United States
(12) Patent Application Publication
(10) Pub. No.: US 2015/0040729 A1
(43) Pub. Date: Feb. 12, 2015

(54) SOCKET

(71) Applicant: Yu-Hua OU, Taichung City (TW)

(72) Inventor: Yu-Hua OU, Taichung City (TW)

(21) Appl. No.: 13/960,728

(22) Filed: Aug. 6, 2013

(51) Int. Cl. B25B 23/00; B25B 13/06

(52) U.S. Cl. CPC B25B 23/0035; B25B 13/06
USPC 81/121.1

(57) ABSTRACT

The present invention provides a socket. A tubular body has a first end has a through hole, an internal wall of the through hole, a receiving groove formed in the internal wall of the through hole and at least one bead aperture perforated through the tubular body and communicated with the receiving groove. A spiral spring is disposed in the receiving groove and has an axis and a plurality of elastic coils extending along the axis. At least one bead body is disposed in the bead aperture and abutted by the elastic coils of the spiral spring, and hence the bead body is partially protruded out of the bead aperture. Therefore, when assembled to or combined with a wrench, the socket can fixedly connect with the wrench; hence, the socket can achieve excellent rotation effect when the wrench rotates the socket.

### BACKGROUND OF THE INVENTION

1. Field of the Invention

The present invention relates to a socket in which a spiral spring fixedly connects the socket with a wrench tool to enable the wrench tool to carry out excellent rotation.

2. Description of the Prior Art

As do-it-yourself (DIY) becomes popular, hand tools advance quickly and become user-friendly for the public. In the prior arts, the socket wrench uses the ratchet to be fixedly disposed to a mounting member, and the mounting member has a downwardly protrusive mounting head, which can joint with various sizes of sockets, so as to loose or tighten different sizes of screw nuts. This assembling way makes the wrench, mounting member and socket unable to be used separately. As such, nowadays, plenty of sockets which cooperate with the mounting head of socket wrench detachably have been invented in the market, and hence the mounting head can cooperate with different sockets at will so as to loose or tighten different sizes of screw nuts.

Regarding the socket inventions in the market, TW M301733 discloses a socket of a wrench in which a concave hole 15 is opened on a lateral face of a pivotal mounting portion of a socket 10. The concave hole 15 is filled with a spring 16 and a round bead 13, and the elastic force of the spring 16 is used to abut against the round bead 13, so the round bead 13 is partially protruded out of the concave hole 15 of the pivotal mounting portion 11. When the socket 10 cooperates with a socket wrench 20, the round bead 13 is abutted against the internal wall of a lock hole 21 of the socket wrench 20 via the elastic force of the spring 16 to serve as a connection between the socket and the wrench.

In addition, U.S. Pat. No. 7,325,468 discloses a socket, in which a through hole 11 and a concave groove 13 are opened on a lateral face of a pivotal mounting portion 10 of the socket 1, and a fixed end 141 of an elastic member 14 is mounted in the concave groove 13. A free end 142 of the elastic member 14 has a positioning protrusion 143 corresponding to the size of the through hole 11; therefore, via the elastic force of the elastic member 14, the positioning protrusion 143 can elastically disposed in the through hole 11. During operation, the elastic member 14 is flexibly abutted against and stuck in a lock hole of a wrench via the elastic force of the elastic member 14 to connect the socket and the wrench.

However, in the above-mentioned prior arts, the springs or elastic members of the sockets cannot provide strong elastic force in practice nor fixedly connect the socket with the wrench effectively. Besides, when the springs or the elastic members of the prior arts are used for a long time, the elastic member would be fatigued or the elastic force would be deteriorated, which in turn would affect the connection effect between the socket and the wrench as well as the service life and usage effect.

The present invention is, therefore, arisen to obviate or at least mitigate the above-mentioned disadvantages.

### SUMMARY OF THE INVENTION

The main object of the present invention is to provide a socket in which a spiral spring is served as a stable connection when the socket is assembled to and combined with a wrench, and excellent rotation effect will be achieved when the wrench rotates the socket.

The main object of the present invention is to provide a socket which, even in long-term usage, will not have the problems of structural damage or detachment, and the service life can be prolonged.

To achieve the above and other objects, the present invention provides a socket, including a tubular body, a spiral spring and at least one bead body. The tubular body has a first end for registration of a wrench; the first end has a through hole, an internal wall of the through hole, a receiving groove formed on the internal wall of the through hole and at least one bead aperture perforated through the wall of the receiving groove. The spiral spring is disposed in the receiving groove, the spiral spring has an axis and a plurality of elastic coils extending along the axis. The bead body is disposed in the bead aperture and abutted by the elastic coils of the spiral spring so as to partially protrude out of the bead aperture.

The socket of the present invention can strongly and fixedly connect with a wrench when it is combined with or assembled to a wrench, that is the socket will not easily fall off from the wrench and the connection between the socket and the wrench will not be unstable; hence, when the wrench rotates the socket, good rotation effect will be achieved. Furthermore, even if being used for excess time, the socket can still maintain strong elasticity, so the service life can be prolonged effectively without problems like structural damage or detachment.

### BRIEF DESCRIPTION OF THE DRAWINGS

FIG. 1 is a perspective assembly drawing of an embodiment of the present invention;

FIG. 2 is perspective breakdown drawing of an embodiment of the present invention;

FIG. 3 is a cross-sectional view of an embodiment of the present invention which shows the coordination between the spiral spring and the bead body;

FIG. 4 is a drawing (I) showing the socket of the present invention coordinates with a wrench;

FIG. 5 is a drawing (II) showing the socket of the present invention coordinates with a wrench;

FIG. 6 is a drawing (III) showing the socket of the present invention coordinates with a wrench;

FIG. 6A is a partially-enlarged view of FIG. 6;

FIG. 7 is a perspective breakdown drawing of another embodiment of the present invention;

FIG. 8 is a drawing showing the socket of another embodiment of the present invention coordinates with a wrench; and

FIG. 8A is a partially-enlarged view of FIG. 8.

### DETAILED DESCRIPTION OF THE PREFERRED EMBODIMENTS

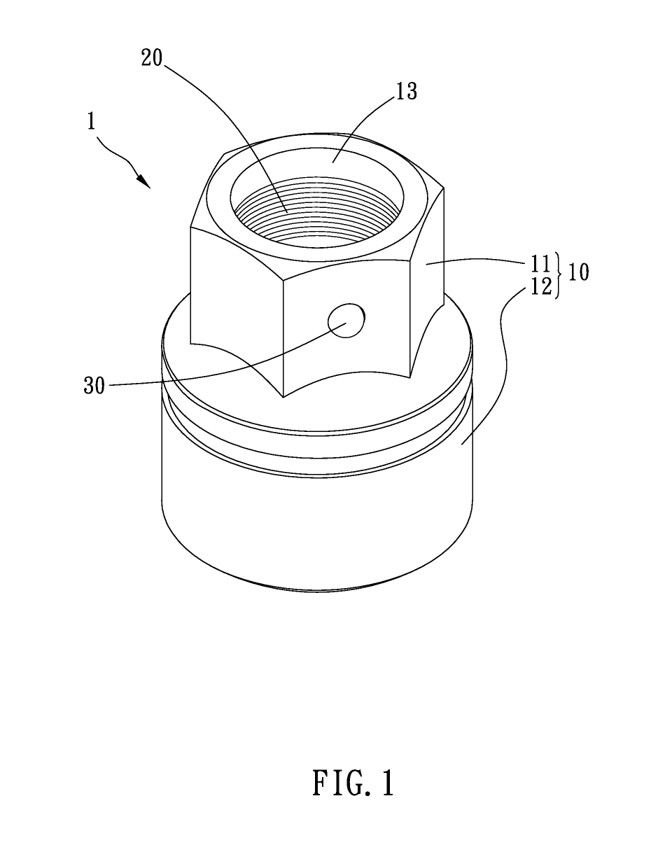

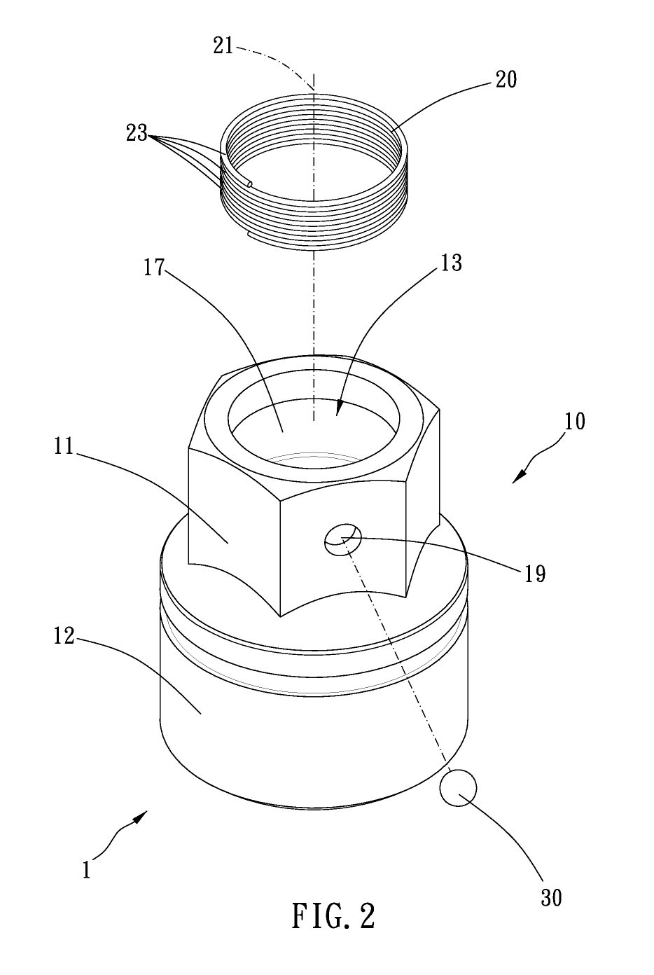

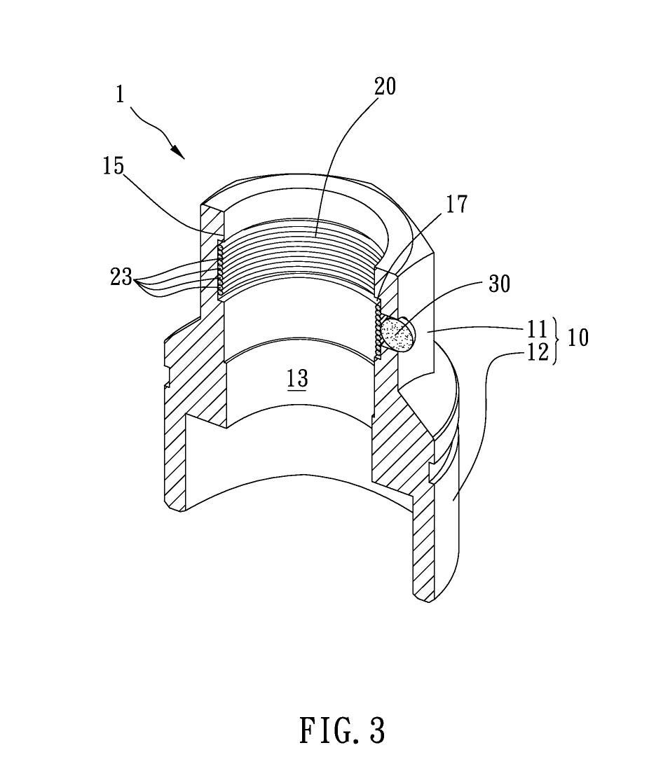

As shown in FIGS. 1 to 4, a socket of an embodiment according to the present invention is provided. The socket includes a tubular body 10, a spiral spring 20 and at least one bead body 30. In this embodiment, the number of the bead body 30 is one, and surely in other embodiments, the number of the bead body 30 can correspond to a number of a bead aperture 19 of the tubular body 10.

The tubular body 10 has a first end 11 and a second end 12 extending from the first end 11; the first end 11 is provided for registration of a wrench 4, and the second end 12 is used to rotate a locking member and a screw piece. The first end 11 has a through hole 13, an internal wall of the through hole 15, a receiving groove 17 formed on the internal wall of the through hole 15 and at least one bead aperture 19 perforated through the tubular body and communicated with the receiving groove 17. In this embodiment, the through hole 13 is perforated through the tubular body. The internal wall of the through hole 15 is recessed to form the receiving groove 17. The receiving groove 17 is formed around the peripheral of the internal wall of the through hole 15. The bead aperture 19 is a hole perforated through a lateral face of the first end 11 as well as communicated with and perpendicular to the receiving groove 17. In this invention, the number of the bead aperture 19 can be designed to be two or more in accordance with the demand of users.

The spiral spring 20 is disposed in the receiving groove 17 and correspondingly attached to the wall of the receiving groove 17, and the spiral spring has a strong elastic energy. The spiral spring 20 has an axis 21 and a plurality of elastic coils 23 extending along the axis 21; every elastic coil 23 is connected with each other and formed by twisting and extending along the axis 21, so the elastic coils 23 can maintain a strong elastic force no matter along or perpendicular to the axis 21, and the spiral spring 20 uses its elastic tension to stick or attach to the receiving groove 17.

The bead body 30 is disposed in the bead aperture 19. The bead body 30 is stuck and abutted in the bead aperture 19 and is abutted by the tension of the elastic coils 23, so the bead body is partially protruded out of the bead aperture 19.

Consequently, every elastic coil 23 of the spiral spring 20 has strong elastic force no matter along or perpendicular to the axis 21. Not only can the spiral spring 20 be stable in the receiving groove 17 but also the strong elastic tension can be used to perpetually urge the bead body 30 toward the bead aperture 19; therefore, even if under excess usage, the service life can be effectively prolonged without problems such as structural damage, structural detachment or elastic fatigue.

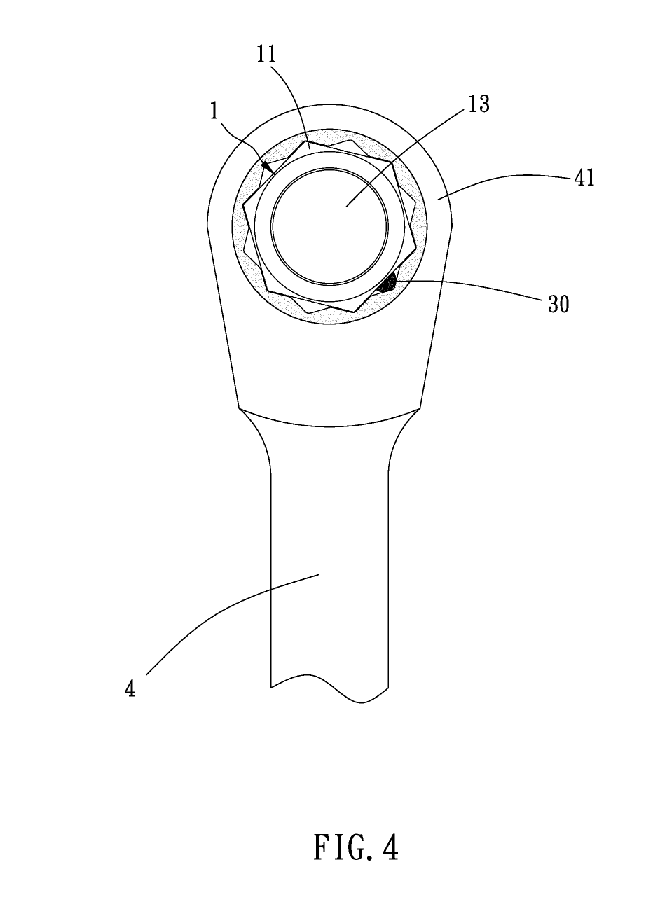

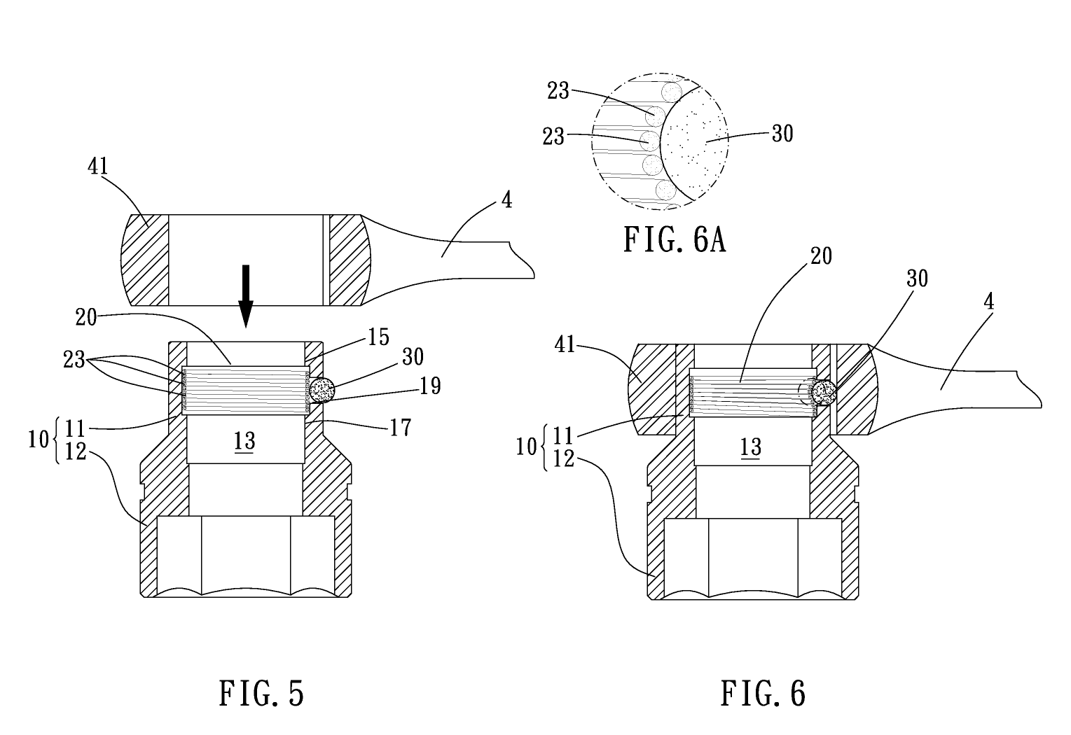

As shown in FIGS. 4, 5, 6 and 6A, when in practice, the first end 11 of the socket 1 is disposed in a lock hole of a tool head 41 of the wrench 4; the second end 12 of the socket 1 can rotate a locking member or a screw piece (not shown). The bead body 30 receives the tension from three (or more) elastic coils 23 of the spiral spring 20, and the bead body 30 can fixedly protrudingly stick in the lock hole of the tool head 41; therefore, the socket 1 is strongly connected and attached to the wrench 4 so as to achieve excellent rotation effect when the wrench 4 rotates the socket 1.

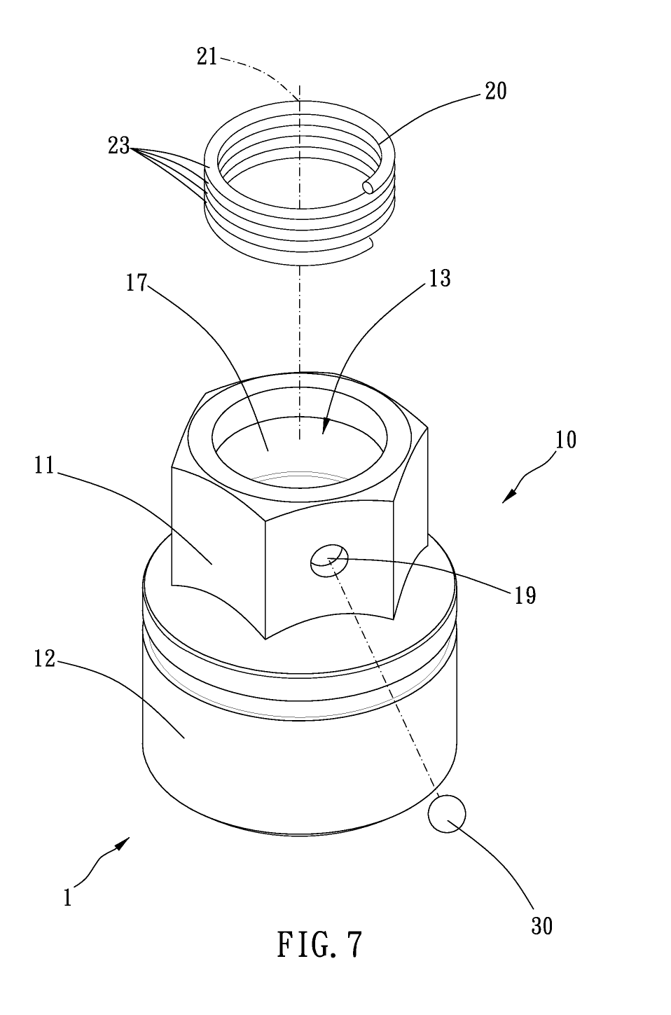

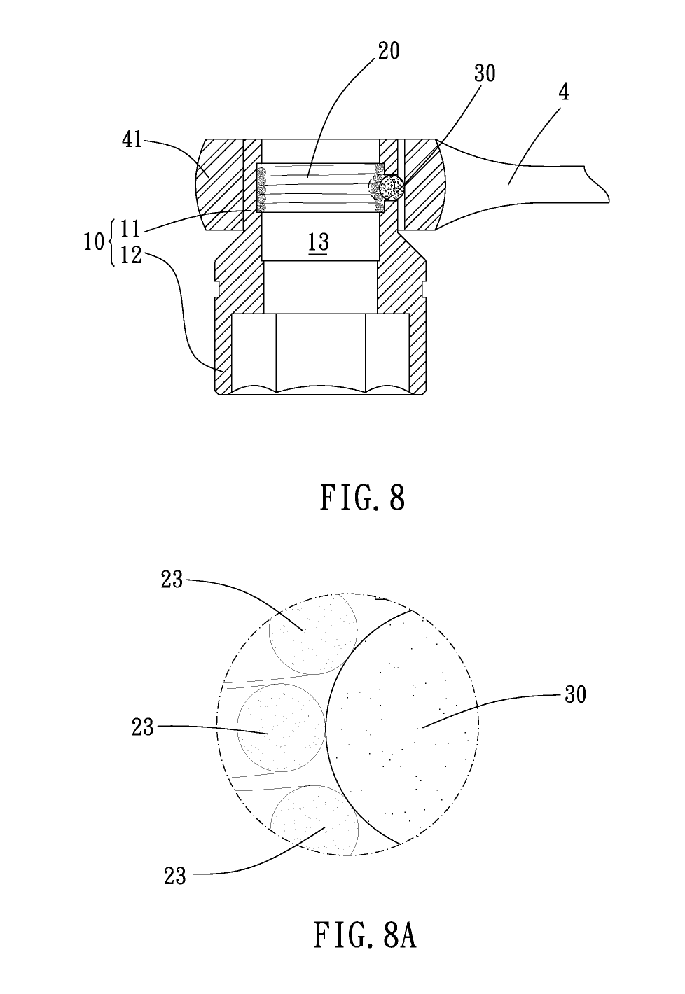

FIGS. 7, 8 and 8A demonstrate another embodiment of the present invention. The difference between this embodiment and the previous embodiment is that the elastic coils 23 of the spiral spring 20 have respectively a diameter, and the diameter is substantially ⅓ of that of the bead body 30; hence, the contact area of every elastic coil 23 and the bead body 30 will reach a certain extent.

In addition, the three (or more) elastic coil 23 of the spiral spring 20 abut against and contact with the bead body 30 (as shown in FIG. 8). The three elastic coils 23 can form strong elastic energy, so even when the bead body 30 is urged toward the elastic coils 23, the elastic coils 23 still have quite good performance of elastic recovery; when the bead body 30 is not urged, it can effectively abut against and partially protrude from the bead aperture 19. Even if being used for a long time, the spiral spring 20 still maintain the same performance of elastic recovery.

To sum up, a socket of the present invention is provided to strongly and fixedly connect with a wrench when it is assembled to or combined with the wrench, and the socket will not easily fall off from the wrench and the connection between the socket and the wrench will not be unstable so as to achieve excellent rotation effect when the wrench rotates the socket. Furthermore, even if under excess usage, there will not be problems like structural damage or detachment, and the service life is effectively prolonged.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A socket, including:
a tubular body, including a first end for registration of a wrench, the first end having a through hole, an internal wall of the through hole, a receiving groove formed on the internal wall of the through hole and at least one bead aperture perforated through the tubular body and communicated with the receiving groove;
a spiral spring, disposed in the receiving groove, the spiral spring having an axis and a plurality of elastic coils extending along the axis; and
at least one bead body, disposed in the bead aperture and abutted by the elastic coils of the spiral spring so as to be partially protruded out of the bead aperture.

2. The socket of claim 1, wherein the tubular body has a second end extending from the first end, and the second end is used to rotate a locking member or a screw piece.

3. The socket of claim 1, wherein the receiving groove is recessed on the internal wall of the through hole, and the bead aperture is perforated through the tubular body and communicated with the receiving groove as well as perpendicular to the receiving groove.

4. The socket of claim 1, wherein the spiral spring is correspondingly attached within the receiving groove.

5. The socket of claim 1, wherein at least three elastic coils of the spiral spring are abuttedly contacted with the bead body so that the bead body is abutted and partially protruded out of the bead aperture.

6. The socket of each of claim 1, wherein the elastic coils have respectively a diameter, and the diameter is substantially ⅓ of a diameter of the bead body.
